(19) United States
(12) Patent Application Publication
(10) Pub. No.: US 2008/0117641 A1
(43) Pub. Date: May 22, 2008

(54) Light emitting diode illumination device powered by liquid crystal display device

(75) Inventors: He-Kang Zhou, Shenzhen (CN); Jian-Hui Lu, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/986,379

(22) Filed: Nov. 21, 2007

(30) Foreign Application Priority Data
Nov. 21, 2006 (TW) 95142993

(51) Int. Cl. F21V 19/02

(52) U.S. Cl. 362/418; 362/382

(57) ABSTRACT

An exemplary light emitting diode illumination device powered by a liquid crystal display device (20) includes a light emitting diode light source (21) and a supporting member (23). The light emitting diode light source receives electrical power from the liquid crystal display device (22). The light emitting diode light source is connected to the liquid crystal display device via the supporting member. Because a power supply circuit of the liquid crystal display device has an electromagnetic interference filter function, a positive feedback function, and a negative feedback function, the brightness of the light emitting diode illumination device powered by a liquid crystal display device is steady.

### FIELD OF THE INVENTION

The present invention relates to light emitting diode (LED) illumination devices, and more particularly to an LED illumination device powered by a liquid crystal display device (LCD).

### GENERAL BACKGROUND

FIG. 4 is an abbreviated circuit diagram of a conventional LED illumination device. The LED illumination device 10 includes a full-bridge rectifier circuit 11, a switch 12, a buck circuit 14, and a plurality of LEDs 13. The full-bridge rectifier circuit 11 includes a first input terminal 111, a second input terminal 112, a positive output terminal 113, and a negative output terminal 114. The switch 12 is connected to the second input terminal 112. The buck circuit 14 includes a resistor and a capacitor connected in parallel. The buck circuit 14 is connected between the positive output terminal 113 and an anode of a first LED 13. The other LEDs 13 are connected in series to a cathode of the first LED 13, and a cathode of the last LED 13 is connected to the negative output terminal 114. The first input terminal 111 and the second input terminal 112 receive an exterior alternating current (AC) voltage. The full-bridge rectifier circuit 11 transforms the AC voltage into a direct current (DC) voltage. The buck circuit 14 transforms the DC voltage into a low DC voltage. The low DC voltage is used for driving the plurality of LEDs 13 to illuminate.

The exterior AC voltage is used as a power supply of the LED illumination device 10, and the exterior AC voltage may fluctuate significantly. Thus a brightness of the plurality of LEDs 13 varies continuously. Furthermore, the LED illumination device 10 is not isolated with respect to the exterior AC voltage, thus it is dangerous for users when the LED illumination device 10 is in operation.

It is desired to provide a new LED illumination device which can overcome the above-described deficiencies.

### SUMMARY

In one aspect, a light emitting diode illumination device includes a light emitting diode light source and a supporting member. The light emitting diode light source receives electrical power from the liquid crystal display device. The light emitting diode light source is mechanically connected to the liquid crystal display device via the supporting member.

In another aspect, a light emitting diode illumination device includes a light emitting diode light source. The light emitting diode light source is supplied with electrical power from the liquid crystal display device. The light emitting diode light source is connected to the liquid crystal display device such that the light emitting diode light source is movable relative to the liquid crystal display device.

Other novel features and advantages will become more apparent from the following detailed description when taken in conjunction with the accompanying drawings.

### BRIEF DESCRIPTION OF THE DRAWINGS

FIG. 1 is a perspective view of an LED illumination device powered by an LCD according to a preferred embodiment of the present invention, the LED illumination device including an LED light source.

FIG. 2 is a block diagram of a power supply circuit of the LCD of FIG. 1.

FIG. 3 is an abbreviated circuit diagram of an illumination circuit of the LED light source of FIG. 1.

FIG. 4 is an abbreviated circuit diagram of a conventional LED illumination device.

### DETAILED DESCRIPTION OF PREFERRED EMBODIMENTS

Reference will now be made to the drawings to describe preferred and exemplary embodiments in detail.

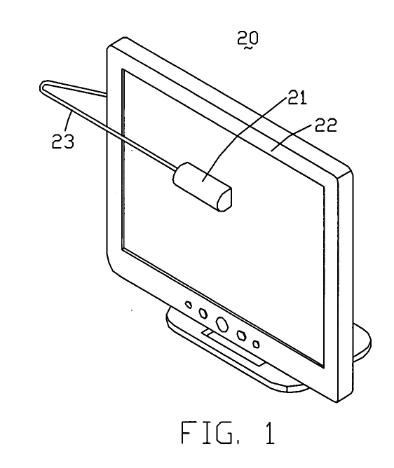

FIG. 1 is a perspective view of an LED illumination device powered by an LCD according to a preferred embodiment of the present invention. The LED illumination device 20 includes an LED light source 21, a supporting member 23, and an LCD 22. The LCD 22 provides electrical power to the LED light source 21. The LED light source 21 is connected to the LCD 22 via the supporting member 23. The supporting member 23 is movable, so that the LED light source 21 can be put behind the LCD 22 when the LED light source 21 is not in use, and can be put in an appropriate position in front of the LCD 22 when the LED light source 21 is in use.

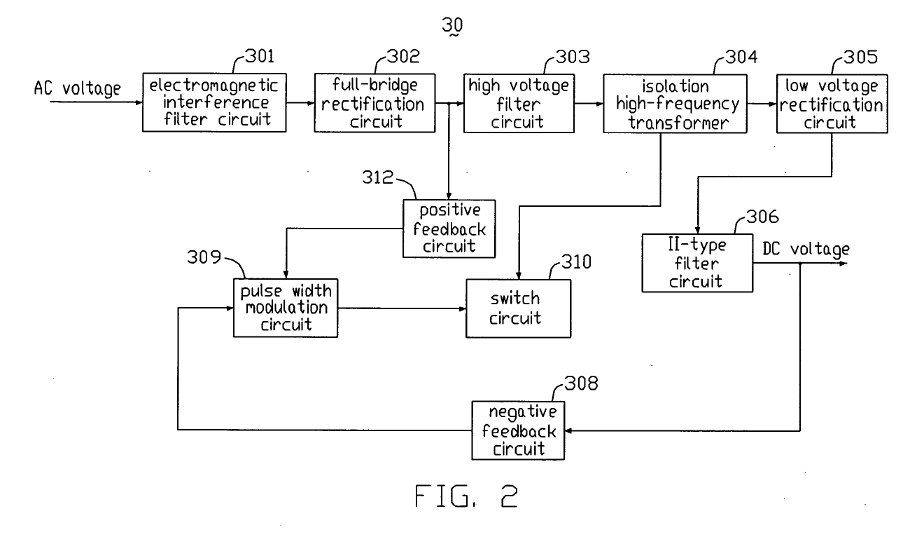

FIG. 2 is a block diagram of a power supply circuit of the LCD 22 of FIG. 1. The power supply circuit 30 includes an electromagnetic interference filter circuit 301, a full-bridge rectification circuit 302, a high voltage filter circuit 303, an isolation high-frequency transformer 304, a low voltage rectification circuit 305, a Π-type filter circuit 306, a negative feedback circuit 308, a pulse width modulation circuit 309, a switch circuit 310, and a positive feedback circuit 312.

When an external AC voltage is inputted into the electromagnetic interference filter circuit 301, the electromagnetic interference filter circuit 301 can stop external electromagnetic interference influencing the power supply circuit 30. The full-bridge rectification circuit 302 transforms an AC voltage outputted by the electromagnetic interference filter circuit 301 into a DC voltage. The DC voltage is transmitted to the isolation high-frequency transformer 304 via the high voltage filter circuit 303. The isolation high-frequency transformer 304 transforms the DC voltage into a low DC voltage. The low DC voltage is transformed into a steady DC voltage via the low voltage rectification circuit 305 and the Π-type filter circuit 306. The steady DC voltage may be a 5V voltage, a 12V voltage, and so on.

The negative feedback circuit 308 detects the steady DC voltage and produces a corresponding first feedback signal. The pulse width modulation circuit 309 receives the first feedback signal, and outputs a corresponding first control signal to the switch circuit 310. The switch circuit 310 turns on or off according to the first control signal to increase or decrease the low DC voltage outputted by the isolation high-frequency transformer 304. Thus, the steady DC voltage outputted by the Π-type filter circuit 306 can be kept at a certain value.

The positive feedback circuit 312 detects the DC voltage outputted by the full-bridge rectification circuit 302 and produces a corresponding second feedback signal. The pulse width modulation circuit 309 receives the second feedback signal, and outputs a corresponding second control signal to the switch circuit 310. The switch circuit 310 turns on or off according to the second control signal to increase or decrease the low DC voltage outputted by the isolation high-frequency transformer 304. Thus, the steady DC voltage outputted by the Π-type filter circuit 306 can be kept at a certain value.

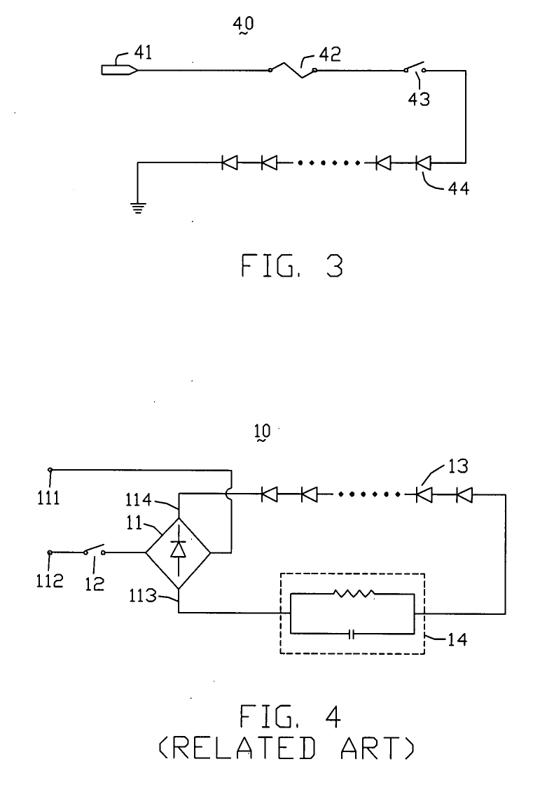

FIG. 3 is an abbreviated circuit diagram of an illumination circuit of the LED light source 21. The illumination circuit 40 includes an input terminal 41, a protective tube 42, a switch 43, and a plurality of LEDs 44. The protective tube 42, the switch 43, and the plurality of LEDs 44 are connected in series between the input terminal 41 and ground. The input terminal 41 receives the steady DC voltage outputted by the power supply circuit 30. When the switch 43 is turned on, the plurality of LEDs 44 emit light steadily. A power rating of the LEDs 44 is very small, thus normal operation of the LCD 22 is not influenced by operation of the illumination circuit 40.

Because the power of the LED illumination device 20 is supplied by the power supply circuit 30 of the LCD 22, and the power supply circuit 30 has an electromagnetic interference filter function, a positive feedback function, and a negative feedback function, the brightness of the LED illumination device 20 is steady. Moreover, the power supply circuit 30 has the isolation high-frequency transformer 304. That is, an input part and an output part of the power supply circuit 30 are isolated from each other. Thus the LED illumination device 20 is much safer for users.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light emitting diode illumination device powered by a liquid crystal display device, the light emitting diode illumination device comprising:
a light emitting diode light source, and
a supporting member,
wherein the light emitting diode light source is configured to receive electrical power from the liquid crystal display device, and the light emitting diode light source is mechanically connected to the liquid crystal display device via the supporting member.

2. The light emitting diode illumination device powered by a liquid crystal display device as claimed in claim 1, wherein the supporting member is movable.

3. The light emitting diode illumination device powered by a liquid crystal display device as claimed in claim 1, wherein the light emitting diode light source comprises an illumination circuit.

4. The light emitting diode illumination device powered by a liquid crystal display device as claimed in claim 3, wherein the illumination circuit comprises an input terminal, a protective tube, a switch, and a plurality of light emitting diodes, and the protective tube, the switch, and the plurality of light emitting diodes are connected in series between the input terminal and ground.

5. The light emitting diode illumination device powered by a liquid crystal display device as claimed in claim 1, wherein the liquid crystal display device comprises a power supply circuit.

6. The light emitting diode illumination device powered by a liquid crystal display device as claimed in claim 5, wherein the power supply circuit comprises an electromagnetic interference filter circuit, a full-bridge rectification circuit, a high voltage filter circuit, an isolation high-frequency transformer, a low voltage rectification circuit, a Π-type filter circuit, a pulse width modulation circuit, and a switch circuit, the pulse width modulation circuit controls the switch circuit to turn on or off, and an external alternating current voltage is transformed into a direct current voltage via the electromagnetic interference filter circuit, the full-bridge rectification circuit, the high voltage filter circuit, the isolation high-frequency transformer, the low voltage rectification circuit, and the Π-type filter circuit under the control of the switch circuit.

7. The light emitting diode illumination device powered by a liquid crystal display device as claimed in claim 6, wherein the power supply circuit further comprises a negative feedback circuit, and the negative feedback circuit detects the direct current voltage and outputs a corresponding feedback signal to the pulse width modulation circuit.

8. The light emitting diode illumination device powered by a liquid crystal display device as claimed in claim 6, wherein the power supply circuit further comprises a positive feedback circuit, and the positive feedback circuit detects an output signal outputted by the full-bridge rectification circuit and outputs a corresponding feedback signal to the pulse width modulation circuit.

9. The light emitting diode illumination device powered by a liquid crystal display device as claimed in claim 6, wherein the direct current voltage is a 5V voltage.

10. The light emitting diode illumination device powered by a liquid crystal display device as claimed in claim 6, wherein the direct current voltage is a 12V voltage.

11. A light emitting diode illumination device powered by a liquid crystal display device, the light emitting diode illumination device comprising:
a light emitting diode light source, wherein the light emitting diode light source is configured to be supplied with electrical power from the liquid crystal display device, the light emitting diode light source is connected to the liquid crystal display device such that the light emitting diode light source is movable relative to the liquid crystal display device.

12. The light emitting diode illumination device powered by a liquid crystal display device as claimed in claim 11, further comprising a supporting member, wherein the light emitting diode light source is connected to the liquid crystal display device via the supporting member and thereby movable relative to the liquid crystal display device.

13. The light emitting diode illumination device powered by a liquid crystal display device as claimed in claim 11, wherein the light emitting diode light source comprises an illumination circuit.

14. The light emitting diode illumination device powered by a liquid crystal display device as claimed in claim 13, wherein the illumination circuit comprises an input terminal, a protective tube, a switch, and a plurality of light emitting diodes, and the protective tube, the switch, and the plurality of light emitting diodes are connected in series between the input terminal and ground.

15. The light emitting diode illumination device powered by a liquid crystal display device as claimed in claim 11, wherein the liquid crystal display device comprises a power supply circuit.

16. The light emitting diode illumination device powered by a liquid crystal display device as claimed in claim 15, wherein the power supply circuit comprises an electromagnetic interference filter circuit, a full-bridge rectification circuit, a high voltage filter circuit, an isolation high-frequency transformer, a low voltage rectification circuit, a Π-type filter circuit, a pulse width modulation circuit, and a switch circuit, the pulse width modulation circuit controls the switch circuit to turn on or off, and an external alternating current voltage is transformed into a direct current voltage via the electromagnetic interference filter circuit, the full-bridge rectification circuit, the high voltage filter circuit, the isolation high-frequency transformer, the low voltage rectification circuit, and the Π-type filter circuit under the control of the switch circuit.

17. The light emitting diode illumination device powered by a liquid crystal display device as claimed in claim 16, wherein the power supply circuit further comprises a negative feedback circuit, and the negative feedback circuit detects the direct current voltage and outputs a corresponding feedback signal to the pulse width modulation circuit.

18. The light emitting diode illumination device powered by a liquid crystal display device as claimed in claim 16, wherein the power supply circuit further comprises a positive feedback circuit, and the positive feedback circuit detects an output signal outputted by the full-bridge rectification circuit and outputs a corresponding feedback signal to the pulse width modulation circuit.

19. The light emitting diode illumination device powered by a liquid crystal display device as claimed in claim 16, wherein the direct current voltage is a 5V voltage.

20. The light emitting diode illumination device powered by a liquid crystal display device as claimed in claim 16, wherein the direct current voltage is a 12V voltage.
